(19) United States
(12) Patent Application Publication
(10) Pub. No.: US 2014/0131347 A1
(43) Pub. Date: May 15, 2014

(54) ASPHALT PATCH CONTAINER FOR MICROWAVE HEATING

(71) Applicant: CRIUS TECH LLC, Minnetonka, MN (US)

(72) Inventor: Mark ELIOT, Minnetonka, MN (US)

(73) Assignee: CRIUS TECH LLC, Minnetonka, MN (US)

(21) Appl. No.: 13/899,001

(22) Filed: May 21, 2013

Related U.S. Application Data
(60) Provisional application No. 61/649,671, filed on May 21, 2012.

(51) Int. Cl. H05B 6/80; E01C 23/00; E01C 11/00

(52) U.S. Cl. CPC H05B 6/80; E01C 11/005; E01C 23/00
USPC 219/762; 404/79; 432/253

(57) ABSTRACT

An apparatus and method for small scale heating of an asphalt material suitable for repair and/or resurfacing of paved surfaces, most preferably where the material is placed in a small microwavable container.

### RELATED APPLICATIONS

The present application claims priority to, and incorporates by reference, U.S. Provisional Patent Application No. 61/649,671 filed on May 21, 2012.

### BACKGROUND OF THE INVENTION

1. Field

This invention relates to an apparatus and method for heating an asphalt patching and surfacing product. In particular, the invention relates to an apparatus and method for small scale heating of an asphalt material suitable for repair and/or resurfacing of paved surfaces.

2. Background

Paved surfaces, most commonly comprised of asphalt or concrete, are considered very durable; however, over time they need maintenance and repair even under the best of conditions. As a result of such things as poor drainage, excessive loads, weathering, poor design, poor construction, exposure to harsh chemical, and the like the surfaces degrade and require repair.

There are limited options for repairing or patching a paved surface with asphalt materials. Asphalt, most generally, is a mixture of bitumen (an oil product) and various grades of aggregate/rock. Asphalt may also contain other additives such as emulsifiers, cut back agents, polymers, etc.

Most commonly surfaces are patched or repaired with hot asphalt patching, which normally involves a professional asphalt crew on-site with the equipment necessary to place hot asphalt onto the surface. This option is beyond the reach of the DIY/novice, because it requires substantial equipment and professional expertise.

Asphalt is normally mixed at high heat, where temperatures can exceed 300° F. The asphalt normally will be applied at temperatures at or above 185° F. It is not practical for a home owner/nonprofessional to mix and apply hot mix asphalt because it is typically produced only by large asphalt plants and sold with minimum tonnage shipments to commercial companies only.

Another option, more recently developed, is cold asphalt patching, which involves the application of a cold asphalt product to the paved surface. These products are available in small quantities and from some home improvement stores, which brings them within the reach of nonprofessionals.

Unfortunately, cold patching materials are generally not of a suitable quality to make them worth the investment in time and money. The products lack the durability of hot mix asphalt, and are prone to granulating relatively quickly. Also, the products do not normally achieve suitable hardness. As a results the repairs are very temporary thereby producing unsatisfactory results.

Thus, a need exits for a method and apparatus to repair or patch paved surfaces that provides the durability of hot asphalt that is within the means of nonprofessionals to accomplish.

### BRIEF DESCRIPTION OF THE FIGURES

FIG. 1 shows the container of the present invention, prior to being heated.

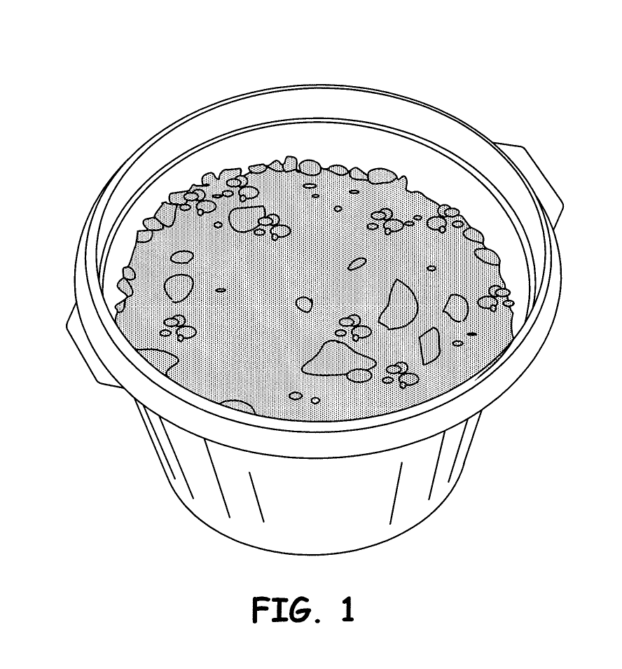

FIG. 2 shows the container after being placed in a conventional microwave oven.

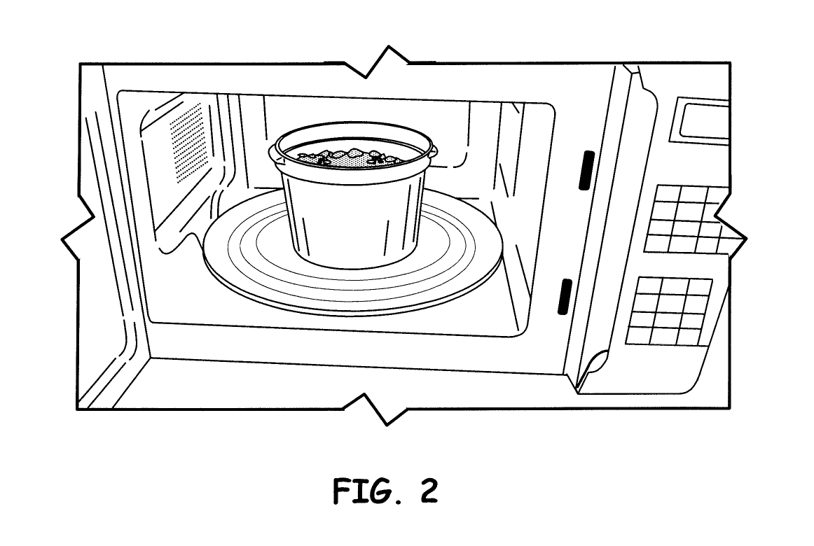

FIG. 3 shows the container in the oven with the timer set to 2 minutes.

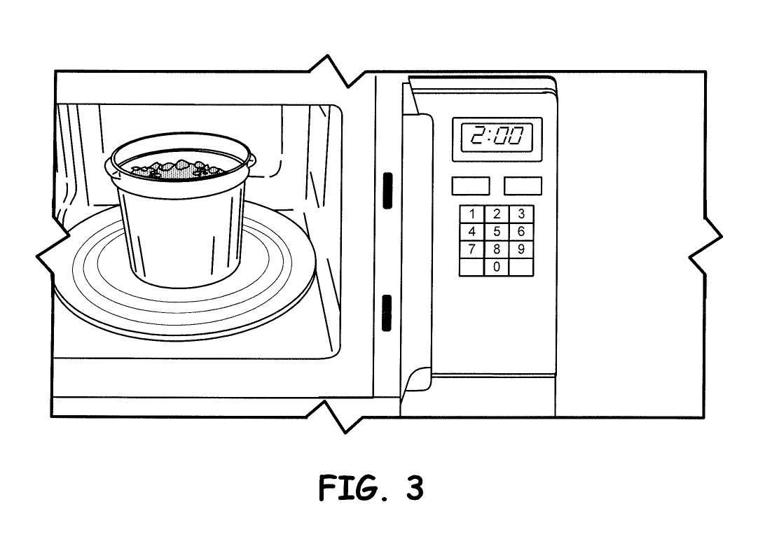

FIG. 4 shows the container after being heated in the oven, with the temperature shown.

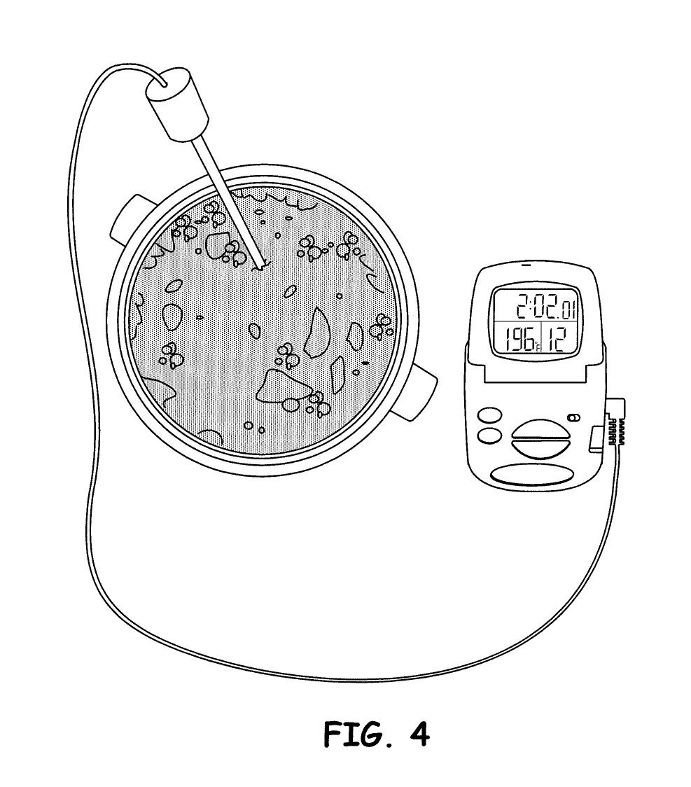

FIG. 5 shows a location for patching prior to application of the heated material.

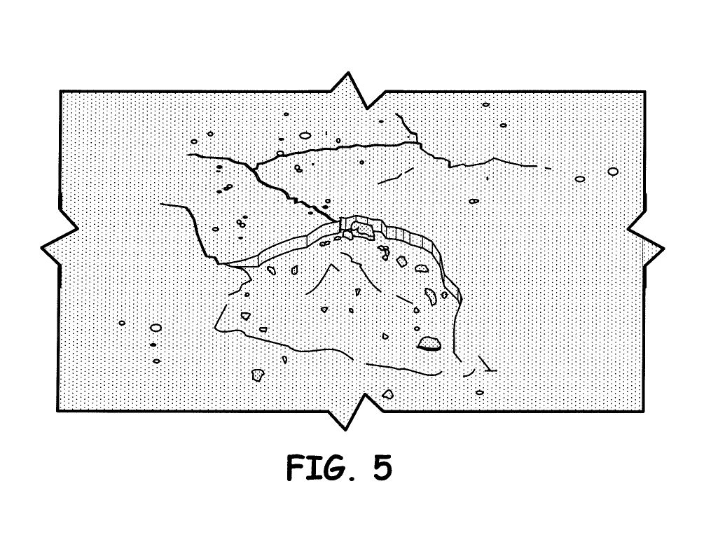

FIG. 6 shows the heated material being placed from the container into the patching location.

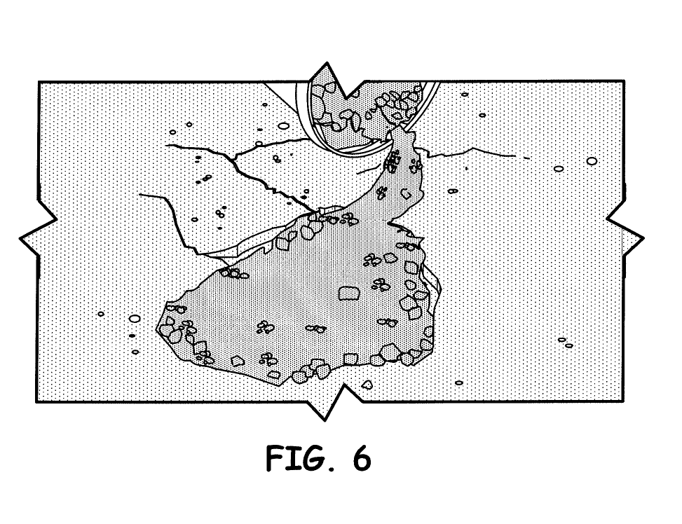

FIG. 7 shows a tamper finishing the patching.

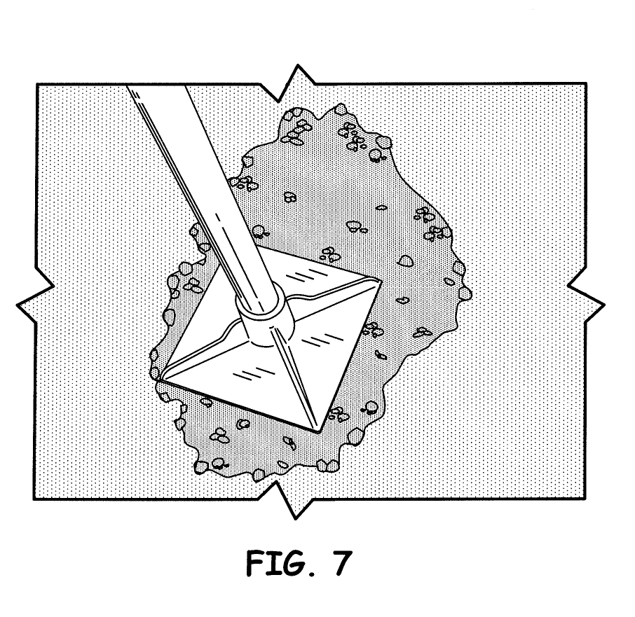

### DETAILED DESCRIPTION OF THE PREFERRED EMBODIMENTS

The present invention comprises a hot mix asphalt product that is packaged in small sized microwavable containers that can be used to patch and repair paved surfaces.

The process should begin with cleaning any dirt/debris from the repair site. Also, any vegetation should be removed from area of pavement needing patching. The patching material will be placed in a suitable sized microwavable container. The lid of the container should be removed, and the container can be placed in a microwave oven (household microwaves are suitable).

The container should be heated on high from between 2-6 minutes (depending on microwave power), preferably to allow the contents to reach approximately 180° F. or higher. Shorter times are possible. The container is then removed from the microwave oven, using care not to spill the contents, oven mitts are suggested. The contents are then poured on the pavement where patch is needed. A compaction tool is used to compact the material keeping in mind that higher compaction yields better results. The patched area should be left to cool until such time at the surface has completely hardened.

Suitable products include generally available asphalt resurfacer products, including those containing a blend of liquid asphalt or emulsions (engineered and non) mixed with recycled asphalt products or virgin aggregates, such as the SUPERMAT product available from Crius Corp. Other similar products are believed to be suitable as well.

The container can be made of any commercially available microwavable material, including containers made from polyethylene terephthalate (PET), high density polyethylene (HDPE), PVC, polyvinyl chloride, vinyl, low density polyethylene (LDPE), polypropylene, polystyrene, styrene, polystyrene foam, polycarbonate, and other materials.

Given the nature of the product in the container and the desirability to avoid leaks and spills the most durable containers are preferred.

In the Figures, the container and product are shown. The container is preferably of a size suitable for use with a household size microwave oven. In particular, the container can range from 1 quart to 2 gallons in size. The Figures show a container placed in the microwave, heated for approximately 2 minutes and was heated to about 200° F. Times and temperatures will vary based on the size of the container, density of the material, and the nature of the microwave oven. The product is then spread onto a prepared surface in need of repair, and compacted.

The present invention eliminates, or substantially eliminates, the problems of the prior art. The invention provides a method and apparatus for the small scale, nonprofessional, use of a hot asphalt resurfacer product. Prior to this invention it was not possible for the nonprofessional to easily repair/patch paved surface with asphalt products.

While the preferred embodiment of the invention has been described in reference to the Figures, the invention is not so limited. Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A container, comprising:
structural elements forming an exterior to contain and patching material, wherein the container is adapted to be placed in an oven thereby heating the material to a temperature sufficient to be applied to pavement patching.

2. The container of claim 1 wherein the patching material is comprised of asphalt.

3. The container of claim 1 wherein the oven is a microwave oven.

4. The container of claim 3 wherein the oven is a household microwave oven.

5. A method of pavement patching, comprising:
providing a container having structural elements forming an exterior to contain and patching material;
placing the container in a microwave oven;
heating the material in the oven to a temperature suitable for patching;
placing the contents into a location for patching;
finishing the patching by smoothing and tamping the material into place.
